(19) United States
(12) Patent Application Publication
(10) Pub. No.: US 2020/0261933 A1
(43) Pub. Date: Aug. 20, 2020

(54) PAINT SPRAYER

(71) Applicant: TTI (MACAO COMMERCIAL OFFSHORE) LIMITED, Macau (MO)

(72) Inventor: Isiah D. Smith, Greenville, SC (US)

(21) Appl. No.: 16/279,353

(22) Filed: Feb. 19, 2019

(51) Int. Cl. B05B 9/04; B05B 1/30; B05B 9/01

(52) U.S. Cl. CPC B05B 9/0426; B05B 9/0861; B05B 9/01; B05B 1/3026

(57) ABSTRACT

A paint sprayer includes a housing and a syringe assembly coupled to the housing with a reservoir and a plunger positioned within the reservoir. The reservoir is configured to store fluid. The paint sprayer also includes a spray assembly in fluid communication with the syringe assembly. The spray assembly includes a spray nozzle and a spray tip. The spray tip is configured to expel fluid. The paint sprayer further includes a motor pump assembly disposed in the housing and an actuator operable to energize the motor pump assembly to draw fluid from the reservoir and expel it from the spray tip.

### BACKGROUND

The present invention relates to paint sprayers, and particularly, to a syringe assembly for a paint sprayer.

Paint sprayers are used to apply paint to workpieces and walls faster and more efficiently than a paint brush. Paint sprayers typically include a reservoir to contain paint, a nozzle, and a motor that drives a pump to draw paint out of the reservoir and out of the nozzle onto a wall. The reservoirs are often difficult to fill leading to paint spilling in unwanted places and requiring longer cleanup.

### SUMMARY

In one embodiment, the invention provides a paint sprayer including a housing and a syringe assembly coupled to the housing with a reservoir and a plunger positioned within the reservoir. The reservoir is configured to store fluid. The paint sprayer also includes a spray assembly in fluid communication with the syringe assembly. The spray assembly includes a spray nozzle and a spray tip. The spray tip is configured to expel fluid. The paint sprayer further includes a motor pump assembly disposed in the housing and an actuator operable to energize the motor pump assembly to draw fluid from the reservoir and expel it from the spray tip.

In another embodiment, the invention provides a syringe assembly including a reservoir that defines a first end, a second end opposite the first end, and a central axis extending centrally through the tube between the first and second ends. The syringe assembly also includes an end cap coupled to the first end of the reservoir that defines a central opening, a valve positioned in the central opening, and a plunger disposed within the reservoir. The plunger is operable to move between a first forward position adjacent the first end of the reservoir and a second rearward position adjacent the second end of the reservoir. The syringe assembly is configured to be coupled to a paint sprayer in a first position, in which, the paint sprayer is operable to draw fluid from the reservoir, and a second position, in which, the plunger is operable to move from the forward position to the rearward position to draw fluid into the reservoir.

In another embodiment the invention provides a fill assembly for a paint sprayer including a straw assembly having a straw that defines an opening. The straw includes a first end and a second end opposite the first end. The paint sprayer also includes a syringe assembly removably coupled to the second end of the straw. The syringe assembly includes a reservoir that is configured to retain fluid. The reservoir includes a first end, a second end opposite the first end, and a central axis extending centrally through the reservoir between the first and second ends. The syringe assembly also includes a plunger positioned within the reservoir. The plunger is operable to move between a first forward position adjacent the first end of the reservoir and a second rearward position adjacent the second end of the reservoir.

Other aspects of the invention will become apparent by consideration of the detailed description and accompanying drawings.

### BRIEF DESCRIPTION OF THE DRAWINGS

FIG. 1 is a perspective view of a paint sprayer.

FIG. 2 is a second perspective view of the paint sprayer of FIG. 1 with a syringe assembly uncoupled.

FIG. 3 is an exploded view of the syringe assembly of FIG. 2.

FIG. 4 is a cross-section view of the syringe assembly of FIG. 2

FIG. 5 is a plunger of the syringe assembly of FIG. 2.

FIG. 6 is a perspective view of a disjoined fill assembly.

FIG. 7 is perspective cross-section view of the fill assembly of FIG. 5 joined.

FIG. 8 is a perspective view of the fill assembly during operation in a first position.

FIG. 9 is a perspective view of the fill assembly during operation in a second position.

FIG. 10 is a cross-section view of the paint sprayer of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

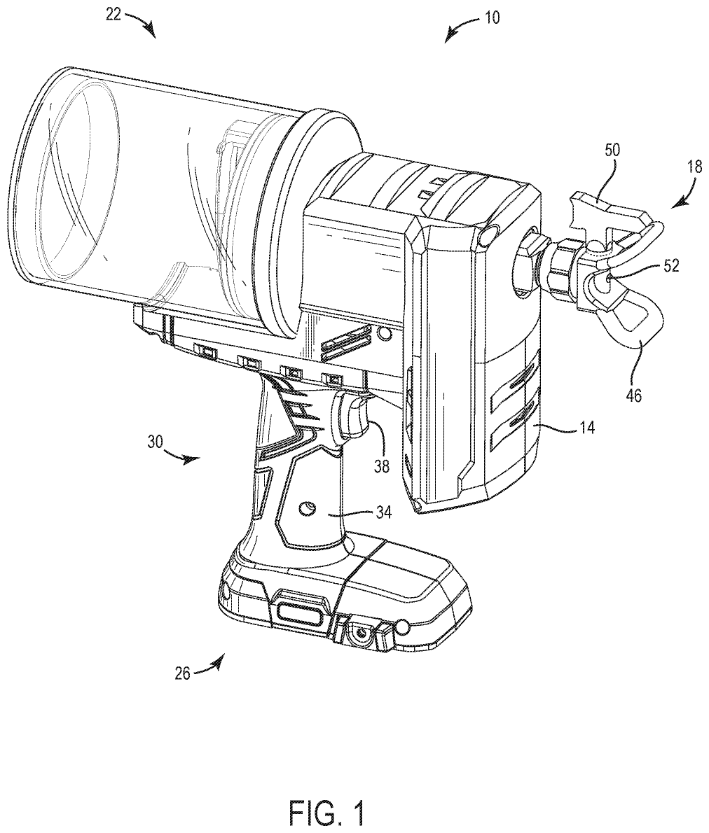

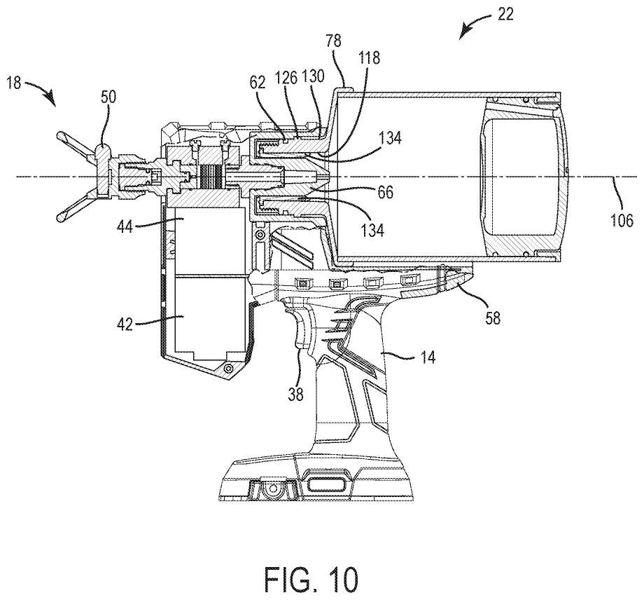

FIG. 1 illustrates a power tool (e.g., a paint sprayer 10) for spraying paint onto a workpiece. The paint sprayer 10 includes a housing 14, a spray assembly 18, and a syringe assembly 22 coupled to the housing 14. The housing 14 defines a battery attachment portion 26 that a battery pack (not shown) is attachable to provide power to the paint sprayer 10. In other embodiments, the paint sprayer 10 may include a power cord for an A/C power source to provide power to the paint sprayer 10. The housing 14 also defines a handle 30 that provides a grip 34 for a user to hold the paint sprayer 10. The handle 30 includes an actuator 38 that may be selectively pressed to provide power from the battery pack to operate the paint sprayer 10. A motor 42 and a pump 44 (FIG. 10) are positioned within the housing 14. The motor 42 receives electrical power from the battery pack when the actuator 38 is depressed to operate the pump 44.

The spray assembly 18 is in fluid communication with the syringe assembly 22 to receive paint or other fluids (e.g., primer or the like) from the syringe assembly 22 to provide a stream of paint onto a workpiece. The spray assembly 18 extends from the housing 14 and is on a diametrically opposite side of the housing 14 from the syringe assembly 22. The spray assembly 18 includes a nozzle 46 and a spray tip 50. The spray tip 50 includes an opening 52 to allow paint to be expelled. In some embodiments, the spray tip 50 may be removably secured to the nozzle 46. In other words, the spray tip 50 may be replaced with new or different spray tips to provide various types of streams onto a workpiece. For example, spray tips may provide a spray stream at various angles and orientations relative to the work piece. Alternatively, spray tips may spray different volumes of paint onto a workpiece. Further, spray tips may provide a fine mist of paint onto a workpiece.

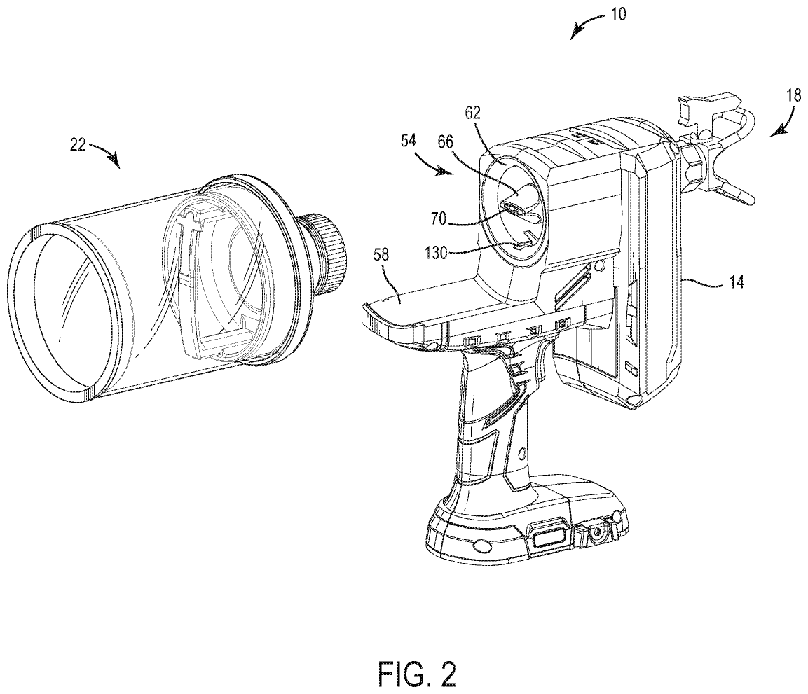

As shown in FIG. 2, the syringe assembly 22 is removable from the paint sprayer 10. As such, the syringe assembly 22 may be in a first position (FIG. 1), in which, the syringe assembly 22 is coupled to the paint sprayer 10 and a second position (FIG. 2), in which, the syringe assembly 22 is detached from the paint sprayer 10.

In the illustrated embodiment, the paint sprayer 10 further includes a coupling assembly 54 that couples the syringe assembly 22 to the housing 14 of the paint sprayer 10. The coupling assembly 54 includes a support 58 and an adapter 62. The support 58 supports the syringe assembly 22 on an opposite side of the paint sprayer 10 as the spray assembly 18. The adapter 62 couples the syringe assembly 22 with the spray assembly 18 to allow the syringe assembly 22 to be in fluid communication with the spray assembly 18. The adapter 62 includes a male fitting 66 extending towards the syringe assembly 22. The male fitting 66 includes a central opening 70 that is in fluid communication with both the spray assembly 18 and the syringe assembly 22 when the syringe assembly 22 is in the first position.

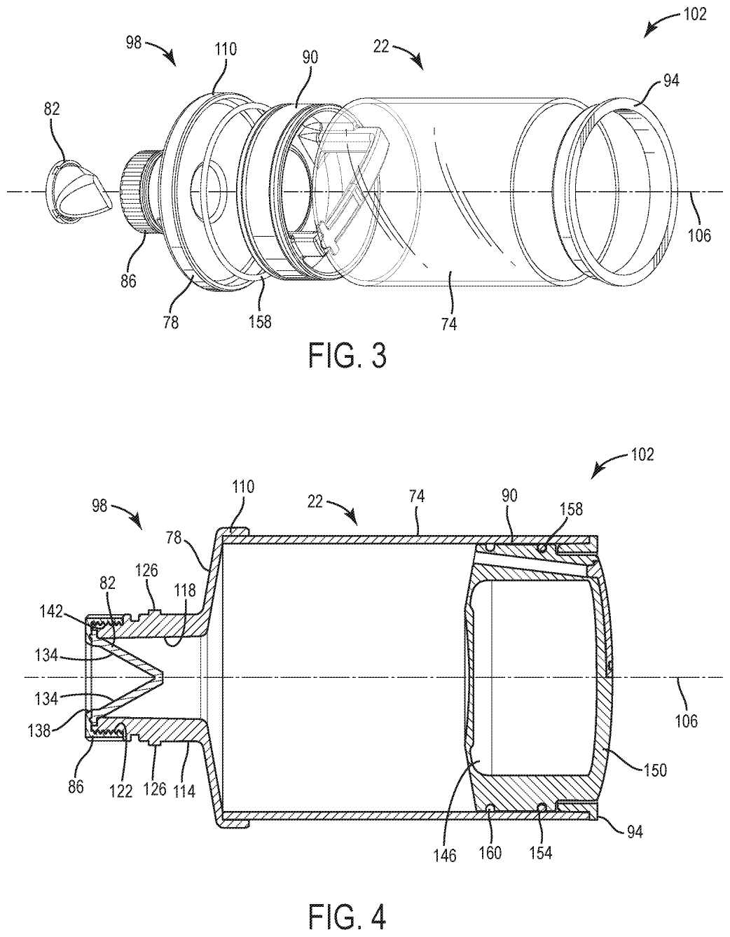

Referring to FIGS. 3 and 4, the syringe assembly 22 includes a paint reservoir (e.g., tube 74), an end cap 78, a valve 82, a retainer 86, a plunger 90, and a retaining ring 94. The tube 74 defines a first or forward end 98 of the syringe assembly 22, a second or rearward end 102 of the syringe assembly 22 that is opposite the first end 98, and a central axis 106 of the syringe assembly 22 extending centrally through the syringe assembly 22 between the first and second ends 98, 102. The tube 74 is generally cylindrical and hollow to store paint within. The end cap 78 is coupled to the first end 98 of the tube 74.

Now referring to FIG. 4, the end cap 78 includes a base 110 and a neck 114. A central opening 118 extends through the base 110 and the neck 114. The neck 114 includes threads 122 and a pair of projections 126 that correspond to a pair of slots 130 (e.g., keyway slots (FIG. 2)) in the adapter 62 to secure the syringe assembly 22 to the paint sprayer 10. The valve 82 is positioned within a central opening 118 of the end cap 78. In the illustrated embodiment, the valve 82 is a flexible valve or duckbill valve including a pair of flaps 134 that allows forward flow and prevents backflow. As such, the flaps 134 are biased to a closed position or no-flow position where the flaps 134 converge. The valve 82 is made out of an elastomeric material (e.g., polymer, silicone, or the like) that allows the valve 82 to be resilient. When flow is forward, the flaps 134 separate from each other to create an opening for fluid to pass. When forward flow is not present, the flaps 134 remain sealed to prevent backflow or a fluid from escaping back through the valve 82. In other embodiments, the valve 82 may be other valves such as butterfly valves, ball valves, or the like.

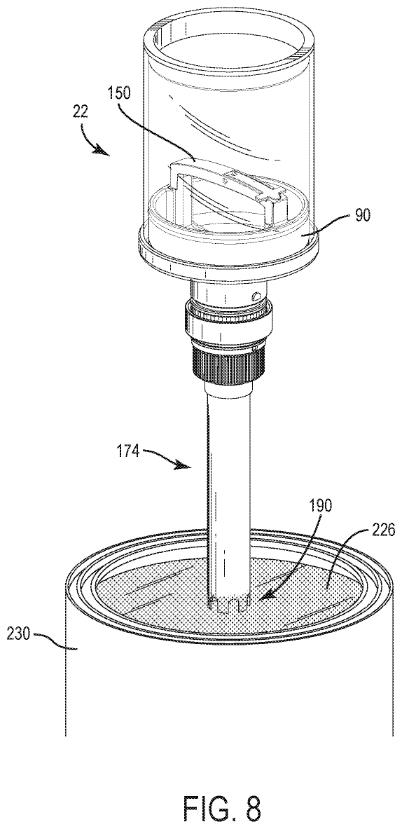

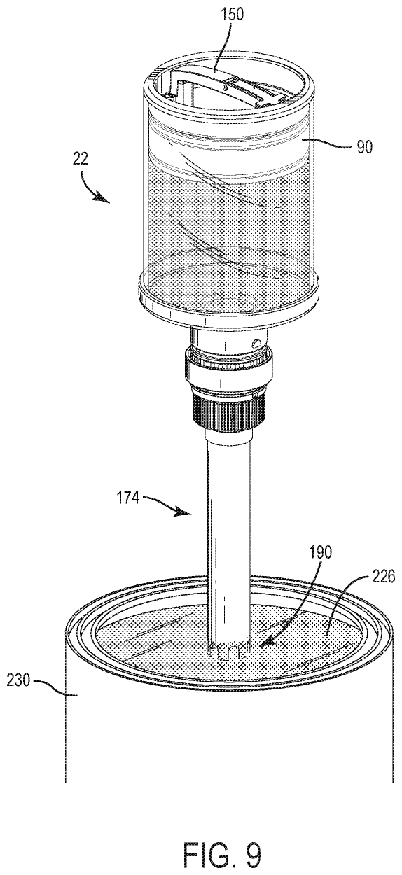

With continued reference to FIG. 4, the retainer 86 includes an opening 138 and internal threads 142 that may be threaded onto the threads 122 of the neck 114 of the end cap 78 to retain the valve 82 within the central opening 118 of the end cap 78. The plunger 90 is positioned within the tube 74 for movement within the tube 74 between a first forward position (FIG. 8) and a second rearward position (FIG. 9). The plunger 90 is limited from movement beyond the tube 74 by the retaining ring 94. The plunger 90 includes a base 146, a handle 150 extending from the base 146, and a recess 154 extending about the plunger 90 that receives an O-ring 158 to seal the plunger 90 within the tube 74. In the illustrated embodiment, there is a single O-ring 158. In other embodiments, more than one O-ring 158 may be received on the plunger 90. For example, the plunger 90 may include a second recess 160 that receives a second O-ring.

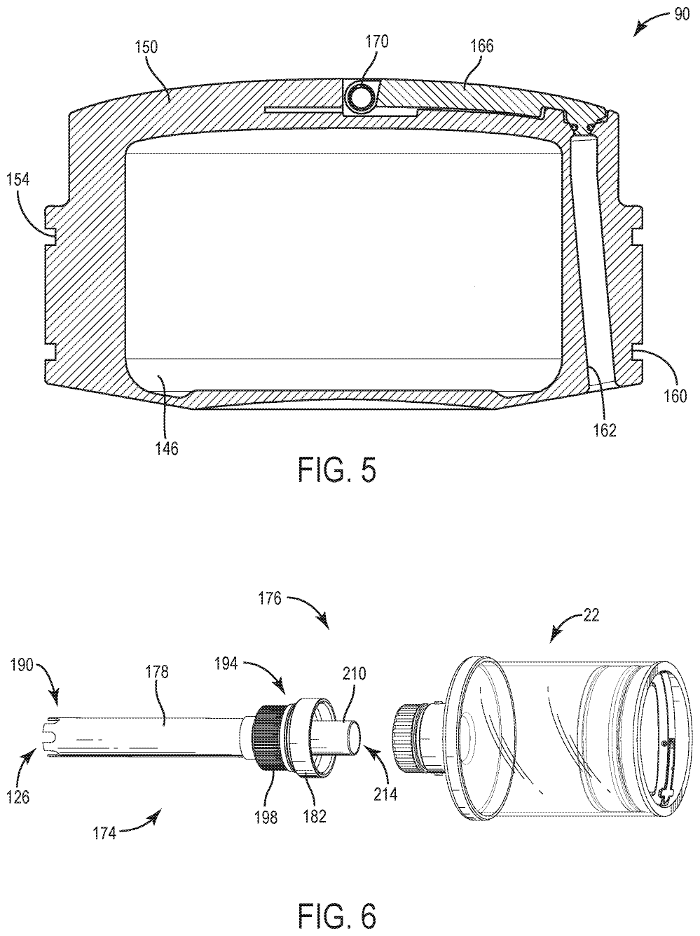

As shown in FIG. 5, the plunger 90 also includes a passageway 162 (e.g., a bleed valve). A cover 166 is biased by a resilient member 170 (e.g., a coil spring) to enclose one end of the passageway 162. The other end of the passageway 162 is in fluid communication with the tube 74. The passageway 162 allows for air trapped inside the syringe assembly 22 to escape during movement of the plunger 90. The pressure of air within the tube 74 moves the cover 166 against the bias of the resilient member 170 to exit the syringe assembly 22. Alternatively, if air enters the tube 74, a user can manually lift the cover 166 to expel the air allowing more room for paint in the tube 74. In some embodiments, the cover 166 may be a flexible member, such as, for example, a stopper positioned over the passageway 162. In other embodiments, the cover 166 may be another mechanical system.

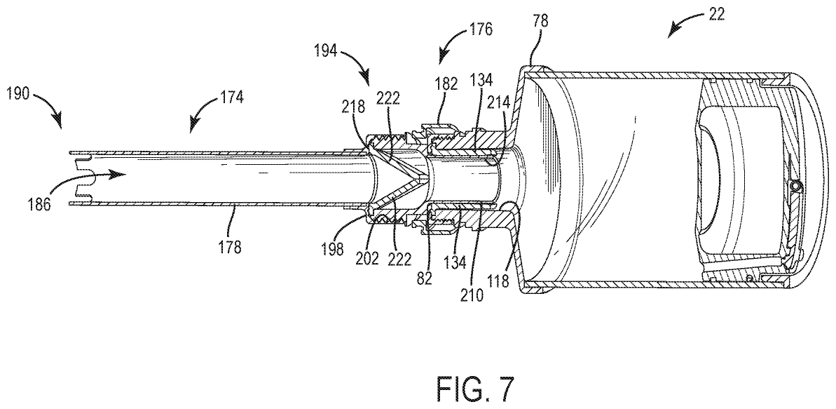

With reference to FIGS. 6 and 7, the syringe assembly 22 may be coupled to a straw assembly 174 to define a fill assembly 176. The fill assembly 176 may be used to fill the tube with paint from a paint bucket 230 (FIG. 8). The straw assembly 174 includes a straw 178 and an adapter 182. The straw 178 defines an opening 186 and includes a first end 190 and a second end 194 opposite the first end 190. A retainer 198 with inner threads 202 is coupled to the second end 194 of the straw 178. The adapter 182 includes outer threads 206 that correspond to the inner threads 202 (FIG. 7) of the retainer 198 to couple the adapter 182 to the straw 178. The adapter 182 also includes a male fitting 210 with a central opening 214 that is aligned with the opening 186 of the straw 178. A valve 218 (e.g., duckbill valve) (FIG. 7) is positioned and secured between the adapter 182 and the retainer 198. The valve 218 is similar to the valve 82 of the syringe assembly 22. The valve 218 includes flaps 222 that are positioned inside the central opening 214 of the adapter 182.

As shown in FIG. 7, the syringe assembly 22 is illustrated in a third position, in which, the syringe assembly 22 is coupled to the straw assembly 174. When the syringe assembly 22 is coupled to the straw assembly 174, the opening 186 of the straw 178 is aligned with the central axis 106 of the syringe assembly 22. Additionally, the male fitting 210 extends into the central opening 118 of the end cap 78 forcing the flaps 134 of the valve 82 apart. In this way, the valve 218 replaces the valve 82 to allow forward flow through the flaps 222 and into the tube 74 of the syringe assembly 22. As such, in the third position, the straw assembly 174 and the syringe assembly 22 are in fluid communication. Although not shown, the syringe assembly 22 may include a lock or similar feature to secure the syringe assembly 22 to the straw assembly 174. For example, the projections 126 may correspond to slots of the adapter 182.

To fill the syringe assembly 22 with paint 226, a user may insert the male fitting 210 of the straw assembly 174 into the central opening 118 of the end cap 72. The male fitting 210 will open the flaps 134 of the valve 82 to allow the syringe assembly 22 and the straw assembly 174 to be in fluid communication. A user can then place the first end 190 of the straw 178 into a bucket 230 of paint 226 (FIG. 8). With the plunger 90 in the forward position, a user can grab the handle 150 of the plunger 90 and begin to move it to the rearward position. As the plunger 90 is moved, paint 226 is drawn through the opening 186 of the straw 178. The forward flow of the paint 226 forces the flaps 222 of the valve 218 of the straw assembly 174 open allowing the paint 226 to enter the tube 74 of the syringe assembly 22. A user may stop moving the plunger 90 either when an adequate amount of paint 226 is within the tube 74 or when the plunger 90 reaches the retaining ring 94, signaling the tube 74 is full (FIG. 9). If any air has been suctioned into the tube 74 while filling, a user may uncouple the straw assembly 174 from the syringe assembly 22 allowing the flaps 134 of the valve 82 to close and preventing backwards flow of the paint 226. While holding the syringe assembly 22 with the end cap 78 pointed down, a user may move the plunger 90 towards the forward position, causing the air trapped in the tank to be expelled through the passageway 162. A user may repeat the steps above to fill the empty space within the tube 74 with more paint 226.

Referring to FIG. 10, once the syringe assembly 22 is filled, a user may couple it to the housing 14 of the paint sprayer by sliding it along the support 58 towards the adapter 62. The projections 126 on the end cap 78 align with the slots 130 of the adapter 62. A user may rotate the syringe assembly 22 about the central axis 106 to secure the syringe assembly 22 to the housing 14. The male fitting 66 of the adapter 62 enters the central opening 118 of the end cap 78 to force the flaps 134 of the valve 82 open. With the flaps 134 open, the syringe assembly 22 and the spray assembly 18 are in fluid communication. A user may then press the actuator 38 to energize the motor 42 of the paint sprayer to operate the pump 44. The pump 42 draws paint from within the tube 74 into a chamber (not shown) of the pump 44. While in the chamber of the pump 44, the paint is pressurized until it reaches a threshold pressure. Once at the threshold pressure, paint is expelled from the opening 52 of the spray tip 50 towards a workpiece in a direction substantially parallel to the central axis 106 of the syringe assembly 22.

A syringe assembly 22 that is operable in a first position, in which it is coupled to a power tool 10, a second position, in which it is uncoupled from the power tool 10, and a third position, in which the syringe assembly 22 is coupled to a straw assembly 174 advantageously allows for quick and simple filling of a reservoir 74 on the syringe assembly 22 so a user may use the power tool 10 to continue painting a workpiece. With less hassle filling a reservoir 74 with paint, a user may finish painting a workpiece earlier.

Various features and advantages of the invention are set forth in the following claims.

What is claimed is:

1. A paint sprayer comprising:
a housing;
a syringe assembly coupled to the housing, the syringe assembly including a reservoir and a plunger positioned within the reservoir, the reservoir configured to store fluid;
a spray assembly in fluid communication with the syringe assembly, the spray assembly including a spray nozzle and a spray tip, the spray tip configured to expel fluid;
a motor pump assembly disposed in the housing;
an actuator operable to energize the motor pump assembly to draw fluid from the reservoir and expel it from the spray tip.

2. The paint sprayer of claim 1, wherein the housing further includes a battery attachment portion that is configured to receive a battery pack.

3. The paint sprayer of claim 1, wherein the housing further includes a coupling assembly, the coupling assembly including a support to support the syringe assembly and an adapter.

4. The paint sprayer of claim 3, wherein the adapter includes a male fitting that extends into the reservoir of the syringe assembly to bring the syringe assembly and spray assembly into fluid communication.

5. The paint sprayer of claim 3, wherein the syringe assembly is coupled to the coupling assembly by sliding it along the support.

6. The paint sprayer of claim 1, wherein the reservoir defines a central axis of the syringe assembly, and wherein the spray tip is configured to expel fluid in a direction substantially parallel to the central axis.

7. The paint sprayer of claim 1, wherein the syringe assembly is on a diametrically opposite side of the housing from the spray assembly.

8. The paint sprayer of claim 1, wherein the syringe assembly is removably coupled to the housing.

9. A system comprising:
the paint sprayer of claim 1; and
a straw assembly including a straw defining an opening, the straw including a first end and a second end opposite the first end;
wherein the syringe assembly is operable in a first position, in which the syringe assembly is coupled to the housing, and a second position, in which the syringe assembly is coupled to the straw assembly.

10. The system of claim 9, wherein in the first position the paint sprayer is operable to draw fluid from the reservoir and in the second position the plunger is operable to move within the plunger to draw fluid into the reservoir.

11. A syringe assembly comprising:
a reservoir defining a first end, a second end opposite the first end, and a central axis extending centrally through the tube between the first and second ends;
an end cap coupled to the first end of the reservoir, the end cap defining a central opening;
a valve positioned in the central opening; and
a plunger disposed within the reservoir, the plunger operable to move between a first forward position adjacent the first end of the reservoir and a second rearward position adjacent the second end of the reservoir;
wherein the syringe assembly is configured to be coupled to a paint sprayer in a first position, in which, the paint sprayer is operable to draw fluid from the reservoir, and a second position, in which, the plunger is operable to move from the forward position to the rearward position to draw fluid into the reservoir.

12. The syringe assembly of claim 11, wherein the plunger includes a base, a handle extending from the base, and a passageway that is in fluid communication with the reservoir.

13. The syringe assembly of claim 12, wherein the handle includes a cover that is resiliently biased to cover one end of the passageway, another end of the passageway being in fluid communication with the reservoir.

14. The paint sprayer of claim 11, wherein the valve is elastomeric.

15. A fill assembly for a paint sprayer comprising:
a straw assembly including a straw defining an opening, the straw including a first end and a second end opposite the first end; and
a syringe assembly removably coupled to the second end of the straw, the syringe assembly including
a reservoir configured to retain fluid, the reservoir including a first end, a second end opposite the first end, and a central axis extending centrally through the reservoir between the first and second ends, and
a plunger positioned within the reservoir, the plunger operable to move between a first forward position adjacent the first end of the reservoir and a second rearward position adjacent the second end of the reservoir.

16. The fill assembly of claim 15, wherein the first end of the straw is configured to be positioned in a fluid, and wherein moving the plunger from the first position to the second position draws the fluid through the opening of the straw and into the reservoir.

17. The fill assembly of claim 15, wherein the straw assembly includes an adapter coupled to the second end of the straw, the adapter including a male fitting that extends into the reservoir to bring the syringe assembly and the straw assembly in to fluid communication.

18. The fill assembly of claim 16, wherein the straw assembly includes a valve disposed within the adapter, the valve operable to allow forward flow from a fluid and prevent backflow from a fluid.

19. The fill assembly of claim 15, wherein the plunger includes a handle configured to be grasped by a user.

20. The fill assembly of claim 15, wherein the opening of the straw is aligned with the central axis of the syringe assembly.
